(19) United States
(12) Patent Application Publication
(10) Pub. No.: US 2026/0235269 A1
(43) Pub. Date: Aug. 13, 2026

(54) LIGHT STAND

(71) Applicant: Jerome Manuel Harris, Cincinnati, OH (US)

(72) Inventor: Jerome Manuel Harris, Cincinnati, OH (US)

(21) Appl. No.: 19/051,844

(22) Filed: Feb. 12, 2025

(51) Int. Cl. F21S 4/28; F21S 9/02; F21V 21/02; F21V 23/00; F21V 23/06; F21Y 103/10

(52) U.S. Cl. CPC F21S 4/28; F21S 9/02; F21V 21/02; F21V 23/001; F21V 23/06; F21Y 2103/10

(57) ABSTRACT

A light stand for directing lighting at a workpiece includes a base, a post, and a light bar. The post is coupled to and extends upwardly from the base. The light bar is coupled to and extends upwardly from a top end of the post. The light bar comprises an elongated body and a lighting assembly coupled to a front side of the elongated body.

The lighting assembly extends between a proximal end and a distal end of the elongated body with respect to the post.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to light stands and more particularly pertains to a new light stand for directing lighting at a workpiece.

### (2) Description of Related Art including information disclosed under 37 CFR 1.97 and 1.98.

The prior art describes myriad lighting apparatuses for directing light as desired toward a workpiece such as a vehicle, artwork, craftwork, and the like. However, the prior art fails to disclose such an apparatus in which a light assembly is mounted along a vertically oriented elongated body mounted on a wheeled base.

### BRIEF SUMMARY OF THE INVENTION

An embodiment of the disclosure meets the needs presented above by generally comprising a base, a post, and a light bar. The post is coupled to and extends upwardly from the base. The light bar is coupled to and extends upwardly from a top end of the post. The light bar comprises an elongated body and a lighting assembly coupled to a front side of the elongated body. The lighting assembly extends between a proximal end and a distal end of the elongated body with respect to the post.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a light stand according to an embodiment of the disclosure.

FIG. 2 is a front view of an embodiment of the disclosure.

FIG. 3 is a top view of an embodiment of the disclosure.

FIG. 4 is a bottom view of an embodiment of the disclosure.

FIG. 5 is a front view of an embodiment of the disclosure.

FIG. 6 is a front view of an embodiment of the disclosure.

### DETAILED DESCRIPTION OF THE INVENTION

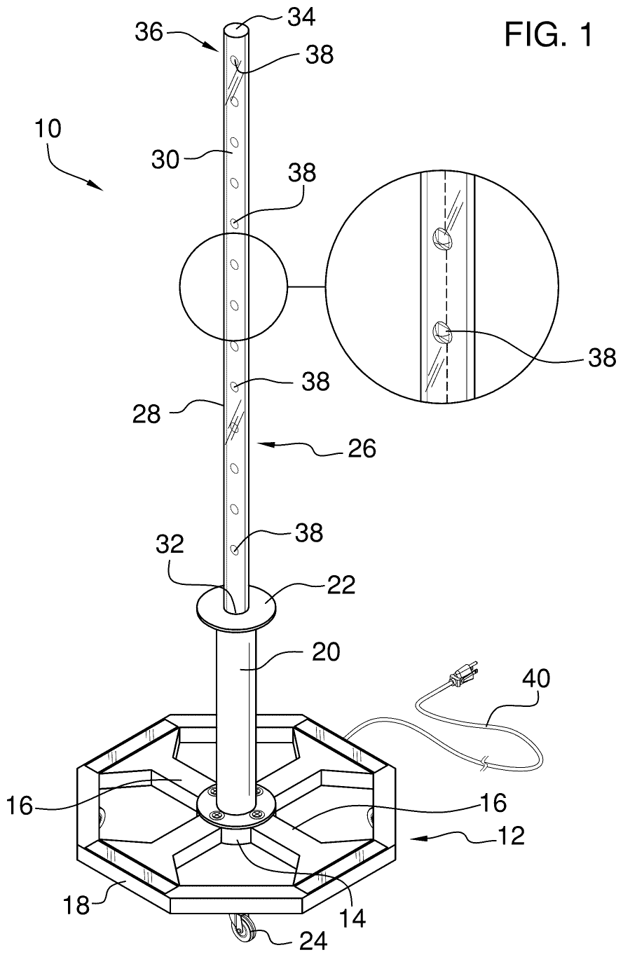

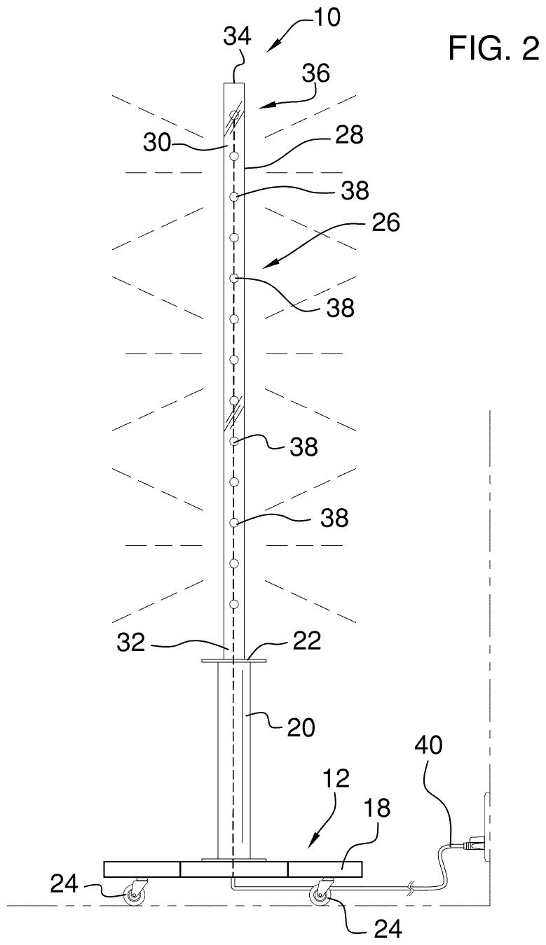

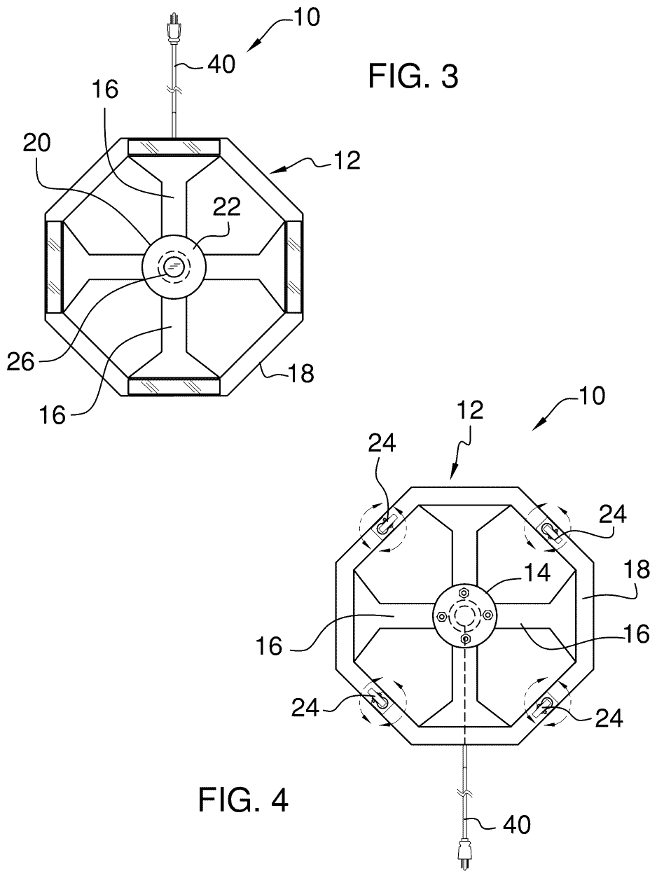

With reference now to the drawings, and in particular to FIGS. 1 through 6 thereof, a new light stand embodying the principles and concepts of an embodiment of the disclosure and generally designated by the reference numeral 10 will be described.

As best illustrated in FIGS. 1 through 6, the light stand 10 generally comprises a base 12 which has a hub 14, a plurality of spokes 16, and a ring 18. The ring 18 surrounding the hub 14, and each spoke 16 of the plurality of spokes 16 is coupled to and extends between the hub 14 and the ring 18. The ring 18 has an octagonal shape but may be circular, hexagonal, or any other suitable shape. A post 20 is coupled to the hub 14 of the base 12 and extends upwardly from the base 12. A plurality of wheels 24 is mounted to the base 12 opposite the post 20. Each wheel 24 comprises a caster which is positioned on the ring 18 of the base 12.

A light bar 26 is coupled to and extends upwardly from a top end 22 of the post 20. The light bar 26 comprises an elongated body 28 and a lighting assembly 36. The elongated body 28 is coaxially aligned with the post 20, and a length of the elongated body 28 is greater than a length of the post 20. The lighting assembly 36 is coupled to a front side 30 of the elongated body 28 such that light may be emitted only forwardly from the elongated body 28. The lighting assembly 36 comprises a plurality of light emitters 38 which are evenly spaced from each other between a proximal end 32 and a distal end 34 of the elongated body 28 with respect to the post 20.

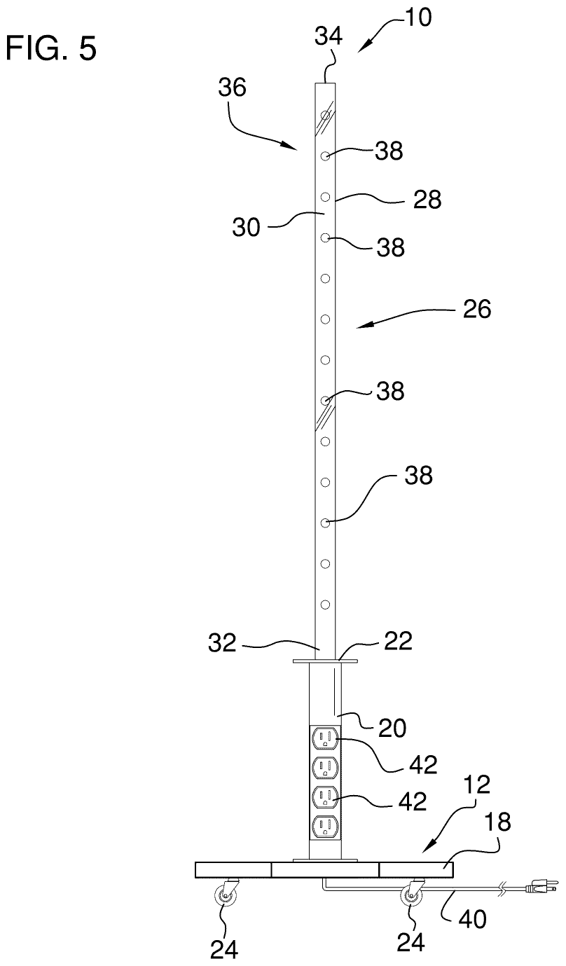

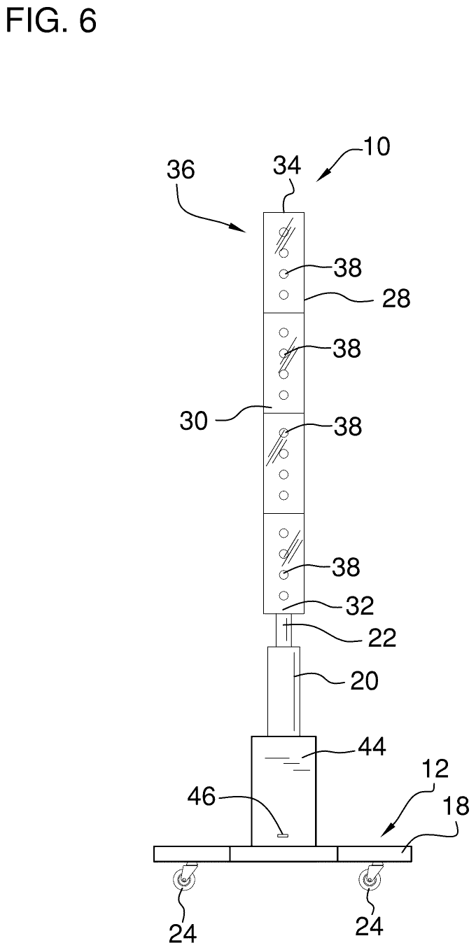

With reference to FIGS. 1-5, embodiments include a power cord 40 which is electrically coupled to the lighting assembly 36 and is configured to electrically couple to an external power supply such as a utility supply via an electrical receptacle. As depicted in FIG. 5, embodiments may comprise a plurality of electrical outlets 42 mounted on the post 20 which are electrically coupled to the power cord 40. FIG. 6 shows an embodiment in which a power source 44 is mounted on the base 12 and is electrically coupled to the lighting assembly 36. The power source 44 comprises a battery but may comprise a capacitor or other suitable energy storage. A charge port 46 is provided for charging the batter via an external charging source.

In use, the lighting assembly 36 is powered to direct light generally forwardly with respect to the elongated body 28 of the light bar 26. Embodiments may include a switch to selectively activate the lighting assembly 36. When activated, the lighting assembly 36 directs light from numerous points along a length of the lighting assembly 36. The light emitters 38 of the lighting assembly 36 are light emitting diodes, but embodiments may comprise other light sources. In some embodiments, a single light source may traverse the length of the lighting assembly 36. The casters enable the light stand 10 to be moved linearly across a floor surface and to be rotated about a vertical axis over the floor surface. In embodiments with the plurality of electrical outlets 42, items may be powered by plugging electrical cords into the electrical outlets 42.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A light stand comprising:
a base;
a post coupled to and extending upwardly from the base; and
a light bar coupled to and extending upwardly from a top end of the post, the light bar comprising:
an elongated body; and
a lighting assembly coupled to a front side of the elongated body, the lighting assembly extending between a proximal end and a distal end of the elongated body with respect to the post;
wherein the base comprises a hub, a plurality of spokes, and a ring, each spoke of the plurality of spokes being coupled to and extending between the hub and the ring, the ring surrounding the hub;
a plurality of wheels mounted to the base, each wheel extending from the base in a direction opposite the post, each wheel of the plurality of wheels being positioned on the ring of the base, the plurality of wheels being radially arranged around the hub such that the post is centered relative to the wheels.

2. (canceled)

3. The light stand of claim 1, wherein the ring has an octagonal shape.

4. The light stand of claim 1, wherein the post is positioned on the hub of the base.

5. (canceled)

6. The light stand of claim 1, wherein the elongated body is coaxially aligned with the post.

7. The light stand of claim 1, wherein a length of the elongated body is greater than a length of the post.

8. The light stand of claim 1, wherein the lighting assembly comprises a plurality of light emitters, the plurality of light emitters being evenly spaced from each other between the proximal end and the distal end of the elongated body.

9. The light stand of claim 1, further comprising a plurality of wheels mounted to the base opposite the post.

10. The light stand of claim 9, wherein each wheel of the plurality of wheels comprises a caster.

11. The light stand of claim 1, further comprising a power cord which is electrically coupled to the lighting assembly, the power cord being configured to electrically couple to an external power supply.

12. The light stand of claim 11, comprising a plurality of electrical outlets mounted on the post, the plurality of electrical outlets being electrically coupled to the power cord.

13. The light stand of claim 1, further comprising:
a power source electrically coupled to the lighting assembly, the power source being mounted on the base, the power source comprising a battery; and
a charge port electrically coupled to the power source.

14. A light stand comprising:
a base, the base comprising a hub, a plurality of spokes, and a ring, each spoke of the plurality of spokes being coupled to and extending between the hub and the ring, the ring surrounding the hub, the ring having an octagonal shape;
a post coupled to and extending upwardly from the base, the post being positioned on the hub of the base;
a light bar coupled to and extending upwardly from a top end of the post, the light bar comprising:
an elongated body, the elongated body being coaxially aligned with the post, a length of the elongated body being greater than a length of the post; and
a lighting assembly coupled to a front side of the elongated body, the lighting assembly comprising a plurality of light emitters, the plurality of light emitters being evenly spaced from each other between a proximal end and a distal end of the elongated body with respect to the post; and
a plurality of wheels mounted to the base, each wheel extending from the base in a direction opposite the post, each wheel of the plurality of wheels being positioned on the ring of the base, the plurality of wheels being radially arranged around the hub such that the post is centered relative to the wheels.

15. The light stand of claim 14, further comprising a power cord which is electrically coupled to the lighting assembly, the power cord being configured to electrically couple to an external power supply.

16. The light stand of claim 15, comprising a plurality of electrical outlets mounted on the post, the plurality of electrical outlets being electrically coupled to the power cord.

17. The light stand of claim 15, further comprising:
a power source electrically coupled to the lighting assembly, the power source being mounted on the base, the power source comprising a battery; and
a charge port electrically coupled to the power source.
